(19) United States
(12) Patent Application Publication
(10) Pub. No.: US 2024/0222797 A1
(43) Pub. Date: Jul. 4, 2024

(54) ION CONDUCTOR AND BATTERY USING THE SAME

(71) Applicant: Panasonic Intellectual Property Management Co., Ltd., Osaka (JP)

(72) Inventors: NOBORU TANIGUCHI, Osaka (JP); YU OTSUKA, Osaka (JP)

(21) Appl. No.: 18/607,608

(22) Filed: Mar. 18, 2024

Related U.S. Application Data
(63) Continuation of application No. PCT/JP2022/028284, filed on Jul. 21, 2022.

(30) Foreign Application Priority Data
Oct. 20, 2021 (JP) 2021-171831

(51) Int. Cl. H01M 50/497; H01M 10/0525; H01M 10/0562; H01M 50/431

(52) U.S. Cl. CPC H01M 50/497; H01M 10/0562; H01M 50/431; H01M 10/0525

(57) ABSTRACT

An ion conductor of the present disclosure includes a Li ion as a Li ion conductive species, and a layered framework structure containing Al, Si, and O, the Li ion being located between layers in the layered framework structure. A battery of the present disclosure includes a positive electrode, a negative electrode, and an electrolyte layer disposed between the positive electrode and the negative electrode. At least one selected from the group consisting of the positive electrode, the electrolyte layer, and the negative electrode includes the ion conductor of the present disclosure.

### BACKGROUND

### 1. Technical Field

The present disclosure relates to an ion conductor and a battery using the same.

### 2. Description of the Related Art

Japanese Unexamined Patent Application Publication No. 2017-91955 discloses an all-solid-state battery using an oxide solid electrolyte.

### SUMMARY

One non-limiting and exemplary embodiment provides an ion conductor including an oxide-based material that is suited for solid lithium-ion secondary batteries.

In one general aspect, the techniques disclosed here feature an ion conductor comprising a Li ion as a Li ion conductive species, and a layered framework structure comprising Al, Si, and O, the Li ion being located between layers in the layered framework structure.

The ion conductor including an oxide-based material that is provided according to the present disclosure is suited for solid lithium-ion secondary batteries.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view illustrating a schematic configuration of a battery according to a third embodiment;

FIG. 2 is a graph illustrating an X-ray diffraction pattern of an ion conductor according to EXAMPLE 1A;

FIG. 3 is a sectional view illustrating a schematic configuration of a pressure forming die;

FIG. 4 is a graph illustrating a Cole-Cole plot obtained by the impedance measurement of the ion conductor according to EXAMPLE 1A;

FIG. 5 is a graph illustrating the results of cyclic voltammetry (CV) measurement of the ion conductor according to EXAMPLE 1A;

FIG. 6 is a graph illustrating discharge characteristics of a half-cell fabricated using the ion conductor of EXAMPLE 1A;

FIG. 7 is a sectional view illustrating a schematic configuration of a pressure forming die;

FIG. 8 is a graph illustrating charge characteristics of the half-cell fabricated using the ion conductor of EXAMPLE 1A;

FIG. 9 is a graph illustrating direct-current conduction characteristics (i-V characteristics) of a Li pump cell fabricated using the ion conductor of EXAMPLE 1A and Li metal electrodes, and a blocking electrode cell composed of blocking electrodes consisting solely of SUS pin current collectors without Li metal electrodes;

FIG. 10 is a graph illustrating the results of a two-minute continuous conduction test of the Li pump cell fabricated using the ion conductor of EXAMPLE 1A and Li metal electrodes, and the blocking electrode cell composed of blocking electrodes consisting solely of SUS pin current collectors without Li metal electrodes;

FIG. 11 is a graph illustrating charge characteristics of a battery of EXAMPLE 3G; and

FIG. 12 is a graph illustrating discharge characteristics of the battery of EXAMPLE 3G.

### DETAILED DESCRIPTIONS

### Underlying Knowledge Forming Basis of the Present Disclosure

Oxides, sulfides, halides, and complex hydrides are inorganic materials known as lithium ion conductors. Among them, oxide-based materials are useful as ion conductors for reasons, such as because they are nonflammable and are excellent in, for example, water resistance and chemical stability. Hereinafter, ion conductors that are oxide-based materials are sometimes written as oxide-based ion conductors.

For example, the oxide-based ion conductors are classified into NASICON type typified by Li_{1.3}Al_{0.3}Ti_{1.7}(PO₄)₃, garnet type typified by Li₇La₃Zr₂O₁₂, perovskite type typified by La_{0.51}Li_{0.34}TiO_{2.94}, LiPON type typified by Li_{2.9}PO_{3.3}N_{0.46}, and borate glass type typified by 50Li₄SiO₄·50Li₃BO₃.

While the mechanism of ion conduction in lithium ion conductors is not clearly understood, it is probable that ions are conducted by tunnel conduction in which Li ions pass through a network structure as in the case of the NASICON type or by hopping conduction in which Li ions move from one to another of interatomic potential stable sites in a crystal bulk. These types of ion conduction occur on the crystalline phase level. Meanwhile, ion conductors used in, for example, batteries are rarely single crystals but are, for example, polycrystals or powder compacts from the point of view of cost. Thus, it is desired that oxide-based ion conductors exhibit ion conductivity even in the state of polycrystals, powder compacts, or the like.

Cost saving of all-solid-state batteries is expected when all-solid-state batteries can be manufactured using existing facilities for the production of lithium-ion batteries using liquid electrolytes (LIB). From the point of view of actual commercialization, all-solid-state batteries can be mass-produced at low cost when it becomes possible to use, for example, ion conductor powder compacts as solid electrolytes.

However, the conventional oxide-based ion conductors are insufficient in flexibility. When, for example, an oxide-based ion conductor is in the form of a powder compact, the resistance at contact interfaces between the particles is relatively high and therefore practical ion conductivity sometimes cannot be obtained. Furthermore, the use of such a conventional oxide-based ion conductor powder compact in a solid electrolyte layer of an all-solid-state battery causes another problem in which the resistance at contact interfaces between the electrode and the solid electrolyte layer is increased and consequently the battery fails to attain a sufficient capacity. That is, the conventional oxide-based ion conductors are not suited in solid-state batteries.

In order to solve the above problems, the present inventors explored for the realization of an oxide-based ion conductor with enhanced flexibility. An oxide-based ion conductor with enhanced flexibility can be formed into a powder compact while ensuring a low resistance at contact interfaces between the particles, and also attains a reduction in resistance increase at the contact interface thereof with an electrode. Specifically, the present inventors focused on clay materials that are oxide materials and are highly flexible at the same time. Clay materials are a general term for compounds that have a layered crystal in which metal ions and silicic acid are bonded to one another. Clay materials exist as natural minerals. The clay materials are viscous because the layers in the layered crystal are loosely bound by hydration bonds or metal ion bonds. When an external force is applied, such interlayer bonds are not broken immediately but exhibit elasticity and relax the stress. The interlayer bonds are broken when a strong force is applied. The clay materials change their viscosity and Young's modulus depending on the water content or the amount of interlayer ions. That is, the clay materials have such a characteristic that the flexibility can be controlled by controlling, for example, the water content. Furthermore, the clay materials exist stably without being decomposed by airborne moisture.

Numerous clay materials that exist as natural minerals have been reported. The basic structure of the clay material has unit lattices that include a tetrahedral sheet (Si₄O₁₀) in which SiO₄ tetrahedral crystal lattices are arranged in a plane, and an octahedral sheet (Al₄O₁₂ or Mg₆O₁₂) in which AlO₆ or MgO₆ octahedral crystal lattices are arranged in a plane. In the basic structure, layers of the above unit lattices are stacked on top of one another in the tetrahedral sheet:octahedral sheet ratio=1:1, 1:2, or 2:1, or cylinders of the unit lattices are crosslinked via a double hydroxide between the cylinders. Natural clay materials are classified into the following typical mineral groups: kaolinite, pyrophyllite, smectite, vermiculite, mica, chlorite, palygorskite, and halloysite (cylindrical). These natural clay materials not only are used as building materials, soils, and foundations, but also are used as functional materials, such as humidity controlling materials, ion exchange materials, and catalysts, in various fields including daily necessities because they can easily take in and release water, metal ions, and, in some cases, even organic matter into and from the gaps between the sheets. Furthermore, these natural clay materials are used as ingredients for ceramic products and potteries. Furthermore, it has recently been found that the natural clay materials exhibit H⁺ or OH⁻ ion conductivity in an aqueous solution or a suspension because of the presence of OH bonds between the layers. It is also known that Na⁺, Ca²⁺, or Al³⁺ is present as interlayer ions in the naturally occurring clay materials.

The present inventors made intensive studies on clay materials including those described above and have developed an ion conductor of the present disclosure described below that is an oxide-based material having ion conductivity and has appropriate viscosity and flexibility.

An ion conductor of the present disclosure comprises a Li ion as a Li ion conductive species, and a layered framework structure comprising Al, Si, and O, the Li ion being located between layers in the layered framework structure.

As already described, the ion conductor of the present disclosure is an oxide-based material and is therefore chemically and physically more stable than sulfide-based or halide-based ion conductors. Furthermore, the ion conductor of the present disclosure has a layered framework structure. That is, the ion conductor of the present disclosure is a layered compound having appropriate viscosity and flexibility similarly to the clay materials described above. Thus, the ion conductor of the present disclosure, even in the form of a powder compact obtained by press-forming of particles, may attain a low resistance at interfaces between the particles. By virtue of the above configuration, the ion conductor of the present disclosure may be used as, for example, a solid bulk ion conductor in an all-solid-state battery.

### Embodiments of the Present Disclosure

Embodiments of the present disclosure will be described below with reference to the drawings.

### First Embodiment

An ion conductor according to the first embodiment comprises a Li ion as a Li ion conductive species, and a layered framework structure comprising Al, Si, and O. The Li ion is located between layers in the layered framework structure.

The ion conductor according to the first embodiment has a layered framework structure containing Al, Si, and O, and further includes a Li ion as a Li ion conductive species located between layers. Similarly to the clay materials described hereinabove, the ion conductor according to the first embodiment has loose metal ion bonds between layers in the layered framework structure and thus has elasticity to relax an external stress, thus exhibiting appropriate flexibility. Furthermore, the ion conductor according to the first embodiment is an oxide-based material. In general, oxide-based materials have higher water resistance than sulfide-based or halide-based materials and are also stable chemically and physically. Thus, the ion conductor according to the first embodiment has excellent characteristics inherent to oxide-based materials, such as water resistance, chemical stability, and physical stability, similarly to the conventional oxide-based ion conductors, and further can exhibit appropriate viscosity and flexibility. Because of having appropriate flexibility, the ion conductor according to the first embodiment, even when used in a battery in the form of, for example, a powder compact, can attain no or little increase in contact resistance between the ion conductor particles and also between the ion conductor and an electrode. That is, the ion conductor according to the first embodiment is an oxide-based ion conductor material suited for batteries.

The layered framework structure of the ion conductor according to the first embodiment may comprise at least one selected from the group consisting of Al oxides having an octahedral structure and Si oxides having a tetrahedral structure. An example of the Al oxides having an octahedral structure is represented by the compositional formula Al₄O₁₂. An example of the Si oxides having a tetrahedral structure is represented by the compositional formula Si₄O₁₀.

For example, the layered framework structure in the ion conductor according to the first embodiment may be such that the layered framework structure has unit lattices that include a Si—O tetrahedral sheet (compositional formula: Si₄O₁₀) in which SiO₄ tetrahedral crystal lattices are arranged in a plane, and an octahedral sheet (compositional formula: Al₄O₁₂) in which AlO₆ octahedral crystal lattices are arranged in a plane, and layers of the unit lattices are stacked on top of one another in the tetrahedral sheet:octahedral sheet ratio=1:1, 1:2, or 2:1, or cylinders of the unit lattices are crosslinked via a double hydroxide between the cylinders.

The layered framework structure comprising Al, Si, and O may further comprise M. Here, M is at least one selected from the group consisting of divalent metal elements and trivalent metal elements. M may be at least one selected from the group consisting of Mg, Fe, Mn, and Zn.

The ion conductor according to the first embodiment may be a material represented by the following compositional formula (1) or (2):

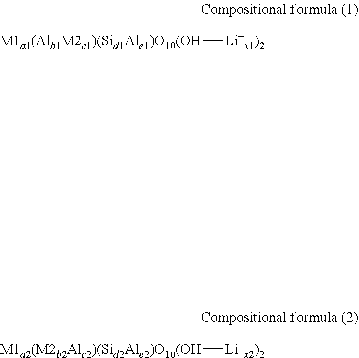

wherein M1 is at least one element selected from trivalent metal elements, M2 is at least one element selected from divalent metal elements, the compositional formula (1) satisfies 0≤a1<0.5, 0≤b1≤2, 0≤c1≤2, 0≤d1≤4, 0≤e1≤0.5, and 0<x1≤1,and the compositional formula (2) satisfies 0≤a2<0.5, 0≤b2≤3, 0≤c2≤2, 0≤d2<4, 0≤e2≤0.5, and 0<x2≤1.

In the compositional formula (1), M1 may be Fe, M2 may be Mg, and e1=0 may be satisfied.

In the compositional formula (2), M1 may be Fe and M2 may be Mg.

The shape of the ion conductor according to the first embodiment is not limited. Exemplary shapes include acicular, spherical, ellipsoidal, scaly, and lamellar. The ion conductor may be particles.

The ion conductor according to the first embodiment may be particles and the average particle size may be less than or equal to 5 μm or may be less than or equal to 3 μm. For example, the average particle size of the ion conductor according to the first embodiment may be greater than or equal to 0.1 μm. Here, the average particle size of the particulate ion conductor is the median diameter and means the particle size (d50) at 50% cumulative volume in the volume-based grain size distribution. The volume-based grain size distribution is measured with a laser diffraction/scattering particle size distribution analyzer.

### Methods for Producing the Ion Conductor According to the First Embodiment

For example, the ion conductor according to the first embodiment is produced by the following method.

There are no natural minerals that are aggregates of solid oxide crystals which have a layered framework structure containing Al, Si, and O and in which Li ions are present between layers. On the other hand, several types of natural minerals exist that are crystals which have a layered framework structure containing Al, Si, and O and in which such cations as Ca²⁺, Na⁺, and H⁺ are present between layers. For example, such a natural mineral with a layered framework structure described above is used as a starting material for the ion conductor according to the first embodiment. The ion conductor according to the first embodiment is obtained by the exchange of the interlayer cations, such as Ca²⁺, Na⁺, and H⁺, with Li ions.

An example of the production method will be described assuming that the target composition is Fe_{0.1}(Al_{1.74}Mg_{0.36})Si₄O₁₀(OH⁻Li⁺_{0.12})₂. In this case, bentonite, which is a natural mineral, is used as the starting material.

A clayey bentonite powder is added to, for example, a 1 mol/L aqueous solution of lithium chloride or lithium nitrate. Next, the solution is stirred for 1 hour while being ultrasonicated. After the stirring, the solution is dehydrated with a centrifuge. The solid component is collected and is added again to a 1 mol/L aqueous solution of lithium chloride or lithium nitrate. The stirring and dehydration are repeated, for example, three times.

For example, the centrifuge dehydration is performed at 5000 rpm for 10 minutes and then at 10000 rpm for 5 minutes.

To remove anions, the solid component obtained is washed with distilled water. The washing is performed until the pH of the solution in which the solid component has been submerged becomes neutral. Through the above operations, cations, such as Ca²⁺, Na⁺, and H⁺, present in the natural mineral are exchanged with Li ions.

After the washing, the solid component is dehydrated and is vacuum dried at 200° C. for 48 hours.

The ion conductor according to the first embodiment is thus obtained.

While the above method has illustrated the production of the ion conductor according to the first embodiment by cation exchange in which the metal ions present between layers in the natural mineral having a layered framework structure are exchanged with Li ions, the ion conductor according to the first embodiment may be synthesized without using natural minerals.

While lithium chloride or lithium nitrate has been illustrated as the salt used to exchange the interlayer metal ions of the natural mineral with Li ions, other water-soluble salt containing lithium may also be used. For example, lithium sulfate, lithium acetate, or lithium hydroxide may be used.

In the above example, the concentration of the aqueous lithium salt solution is 1 mol/L, but the concentration is not limited thereto. For example, the concentration of the lithium salt may be 2 mol/L or 0.5 mol/L.

### Composition Analysis

The compositions of the ion conductor according to the first embodiment and the natural mineral are semi-quantitatively analyzed by, for example, wavelength-dispersive X-ray microanalysis (EPMA). For example, the composition of the interlayer metal ions is quantitatively analyzed by inductively coupled plasma atomic emission spectrometry (ICP-AES).

### Crystal Structure Analysis

For example, the crystal structures of the ion conductor according to the first embodiment and the natural mineral may be evaluated by X-ray diffractometry using Cu-Kαradiation (wavelength: 1.5418 Å). The presence of a layered crystal structure is indicated by a diffraction peak at a diffraction angle 2θ of 2° to 10° in an X-ray diffraction pattern that is obtained. Thus, an X-ray diffraction pattern obtained by X-ray diffractometry of the ion conductor according to the first embodiment using Cu-Kα radiation may have a peak in the range of diffraction angles 2θ greater than or equal to 2° and less than or equal to 10°.

The value of 0 may be calculated from nλ=2d sinθ where d is the spacing distance. The wavelength λ of the Cu-Kα radiation is 1.5418 Å. In this case, the structure may be judged as a layered stack of single sheets when the value of d is greater than or equal to 8.8456 Å.

### Second Embodiment

The second embodiment will be described below. The features described in the first embodiment may be omitted as appropriate.

An ion conductor according to the second embodiment is the ion conductor according to the first embodiment that has a specific form. In the first example, for example, the ion conductor according to the first embodiment is particles, and the ion conductor according to the second embodiment is a pressure-formed body obtained by pressure-forming the particulate ion conductor. This pressure-formed body is a powder compact. For example, the pressure-formed body may be a pellet obtained by pulverizing the ion conductor according to the first embodiment and applying an external pressure to the solid ion conductor particles. For example, the pressure-formed body may be used as a solid electrolyte. For example, the pressure-formed body may be used as a solid electrolyte for batteries.

In the second example, the ion conductor according to the second embodiment is a sintered body obtained by heat-treating the ion conductor according to the first embodiment. For example, the sintered body may be a sheet-shaped sintered body obtained by pulverizing the ion conductor according to the first embodiment, forming the solid ion conductor particles into a sheet, and heat-treating the sheet. For example, the sintered body may be used as a solid electrolyte. That is, for example, the sintered body may be used as a solid electrolyte for batteries.

For example, the solid ion conductor particles that are used to form the ion conductor according to the second embodiment may have an average particle size less than or equal to 5 μm or may have an average particle size less than or equal to 3 μm. For example, the average particle size of the solid ion conductor particles may be greater than or equal to 0.1 μm. As described in the first embodiment, the average particle size of the particulate ion conductor is the median diameter and means the particle size (d50) at 50% cumulative volume in the volume-based grain size distribution. The volume-based grain size distribution is measured with a laser diffraction/scattering particle size distribution analyzer.

The bulk density of the ion conductor according to the second embodiment may be greater than or equal to 60% of the true density of the ion conductor.

### Pulverization

For example, the pulverization of the ion conductor according to the first embodiment is performed by manually or mechanically grinding the ion conductor according to the first embodiment.

For example, the ion conductor is manually ground using an agate mortar and an agate pestle. In the manual grinding of the ion conductor, for example, the grinding time may be 30 minutes to 3 hours, may be 30 minutes to 2 hours, or may be 30 minutes to 1 hour. For example, the grinding time is 30 minutes, 1 hour, or 2 hours.

For example, the ion conductor is mechanically ground by a ball mill method, a vibration mill method, or a bead mill method. For example, the ion conductor may be ground with a planetary ball mill (for example, planetary ball mill Pulverisette 7 manufactured by Fritsch). In the mechanical grinding of the ion conductor, for example, the grinding time may be 30 minutes to 3 hours, may be 30 minutes to 2 hours, or may be 30 minutes to 1 hour. For example, the grinding time is 1 hour.

The mechanical grinding may be dry grinding or wet grinding.

Examples of the solvents used for wet grinding include cyclohexane, toluene, and alcohols.

For example, the table rotational speed (revolution) may be 400 rpm to 900 rpm and may be, for example, 600 rpm.

Mechanical grinding may be performed after manual grinding.

### Grain Size Measurement

As described hereinabove, the grain size of the ion conductor is measured with a laser diffraction/scattering particle size distribution analyzer. For example, the grain size of the ion conductor is measured using laser diffraction/scattering particle size distribution analyzer MT3300 II (manufactured by MicrotracBEL Corp.). For example, water or cyclohexane is used as the dispersion solvent.

### Preparation of Pressure-Formed Body

A pressure-formed body may be prepared using a pressure forming die. FIG. 3 and FIG. 7 are sectional views illustrating a schematic configuration of the pressure forming die. A pressure-formed body may be prepared using the pressure forming die illustrated in FIG. 3 or FIG. 7. While the details will be described in EXAMPLES, a pressure-formed body is produced by applying a pressure to a sample 10 including the ion conductor using an upper punch 20 and a lower punch 30 of the pressure forming die.

For example, the pressure that is applied may be greater than or equal to 3 MPa and less than or equal to 36 MPa.

A hydraulic press machine may be used to apply the pressure. Alternatively, the pressure may be applied with weights or by hands. Still alternatively, the pressure may be applied by pneumatic pressing or isostatic pressing (CIP).

For example, the cylinder diameter of the hydraulic pump of the hydraulic press machine is 14.5 cm².

The bulk density of the pressure-formed body may be calculated by measuring the thickness and the mass of the pressure-formed body with a micrometer and a balance after the compression. For example, the true density may be calculated by determining the volume using a He gas displacement multivolume pycnometer (MICROMERITICS 1305) and measuring the mass separately.

### Preparation of Sintered Body

A powder (for example, 3 g) of the ion conductor is added to distilled water (for example, 20 cc) and the mixture is stirred while being ultrasonicated. For example, the stirring is performed for 3 hours.

The slurry obtained after the stirring is transferred to a Petri dish and is allowed to sediment for 24 hours. Next, the Petri dish is transferred onto a hot plate at 120° C., and the supernatant distilled water is evaporated for 24 hours.

The sheet-shaped ion conductor formed on the Petri dish is transferred to a magnetic or alumina sheath and is heat-treated and dehydrated in an electric furnace at 250° C. for 2 hours. The resultant sheet is subjected to a gauge pressure of, for example, 10 MPa.

A sheet-shaped sintered body is thus obtained.

While the above natural sedimentation method involves distilled water, an aqueous solvent other than distilled water, or an organic solvent may be used. Examples of the organic solvents include ethanol and cyclohexane.

The slurry may be formed into a sheet on a resin, such as polypropylene (PP) or polyethylene terephthalate (PET), by a coating method or a tape casting method.

The sheet-shaped ion conductor may be sintered by dehydration and heat treatment on a hot plate instead of the electric furnace.

### Third Embodiment

The third embodiment will be described below. The features described in the above embodiments may be omitted as appropriate.

A battery of the third embodiment comprises a positive electrode, an electrolyte layer, and a negative electrode. The electrolyte layer is disposed between the positive electrode and the negative electrode. At least one selected from the group consisting of the positive electrode, the electrolyte layer, and the negative electrode comprises the ion conductor according to the first embodiment or the second embodiment.

The battery of the third embodiment contains the ion conductor according to the first embodiment or the second embodiment and thus has excellent charge-discharge characteristics.

The battery of the third embodiment may be an all-solid-state battery.

The battery of the third embodiment may be composed solely of nonflammable materials.

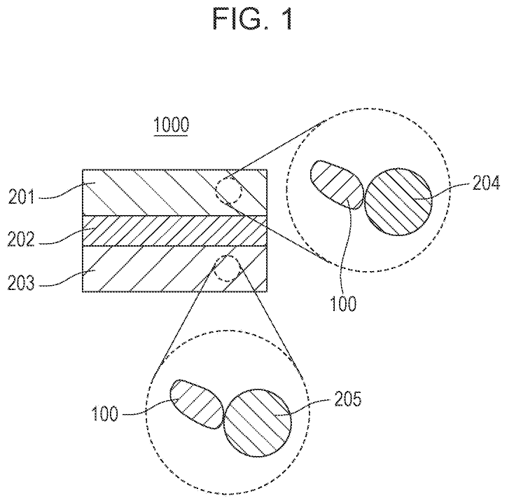

FIG. 1 is a sectional view illustrating a schematic configuration of the battery according to the third embodiment.

A battery 1000 includes a positive electrode 201, an electrolyte layer 202, and a negative electrode 203. The electrolyte layer 202 is disposed between the positive electrode 201 and the negative electrode 203.

For example, the positive electrode 201 contains a positive electrode active material 204 and a solid electrolyte 100.

Examples of the positive electrode active material 204 include lithium-containing transition metal oxides, transition metal fluorides, polyanion materials, fluorinated polyanion materials, transition metal sulfides, transition metal oxyfluorides, transition metal oxysulfides, and transition metal oxynitrides. Examples of the lithium-containing transition metal oxides include LiCoO₂, Li₄Ti₅O₁₂ (hereinafter, written as “LTO”), LiCoPO₄, LiNi_{0.33}Mn_{0.33}Co_{0.33}O₂, LiNi_{0.8}Co_{0.15}Al_{0.05}O₂, Li_{1.2}Ti_{0.4}M_{0.4}O₂, Li_{1.2}Fe_{0.4}Mn_{0.4}O₂, Li₂Mn_{1/2}Ti_{1/2}O₂F, Li_{1.1}Al_{0.1}Mn_{1.8}O₄, LiNi_{0.5}Mn_{1.5}O₄, LiFePO₄, Li₂FeSiO₄, and Li₂CoPO₄F.

The positive electrode active material 204 may be a layered rock salt-type oxide, a spinel-type oxide, or an olivine-type oxide.

For example, the negative electrode 203 contains a negative electrode active material 205 and a solid electrolyte 100.

Examples of the negative electrode active material 205 include metal materials, carbon materials, oxides, nitrides, tin compounds, and silicon compounds. The metal materials may be elemental metals or alloys. Examples of the metal materials include lithium metal and lithium alloys. Examples of the carbon materials include natural graphites, cokes, semi-graphitized carbons, carbon fibers, spherical carbons, artificial graphites, and amorphous carbons. From the point of view of capacity density, preferred negative electrode active materials are, for example, silicon (Si), tin (Sn), silicon compounds, and tin compounds. Specific examples of the negative electrode active material 205 include LTO, MoO₃, MoO₂, TiO₂, V₆O₁₃, TiS₂, MoS₂, and NbSe.

At least one selected from the positive electrode 201 and the negative electrode 203 may contain a conductive auxiliary for the purpose of enhancing the electron conductivity.

Examples of the conductive auxiliaries include:
(i) graphites, such as natural graphites and artificial graphites,
(ii) carbon blacks, such as acetylene blacks and Ketjen blacks,
(iii) conductive fibers, such as carbon fibers and metal fibers,
(iv) carbon fluoride,
(v) metal powders, such as aluminum,
(vi) conductive whiskers, such as zinc oxide and potassium titanate,
(vii) conductive metal oxides, such as titanium oxide, and
(viii) conductive polymer compounds, such as polyaniline, polypyrrole, and polythiophene.

To reduce the cost, a conductive auxiliary belonging to (i) or (ii) may be used.

For example, the solid electrolyte 100 includes the ion conductor according to the first embodiment. The solid electrolyte 100 may be particles including the ion conductor according to the first embodiment as a main component. The particles including the ion conductor according to the first embodiment as a main component are particles that include the ion conductor according to the first embodiment in the highest molar ratio. The solid electrolyte 100 may be particles consisting of the ion conductor according to the first embodiment.

The electrolyte layer 202 contains an electrolyte material. For example, the electrolyte material is a solid electrolyte material. The electrolyte layer 202 may be a solid electrolyte layer. The electrolyte layer 202 may include the ion conductor according to the first embodiment. The electrolyte layer 202 may include a pressure-formed body or a sheet-shaped sintered body that is the ion conductor according to the second embodiment.

The electrolyte layer 202 may include the ion conductor according to the first embodiment in a ratio greater than or equal to 50 mass %. The electrolyte layer 202 may include the ion conductor according to the first embodiment in a ratio greater than or equal to 70 mass %. The electrolyte layer 202 may include the ion conductor according to the first embodiment in a ratio greater than or equal to 90 mass %. The electrolyte layer 202 may consist solely of the ion conductor according to the first embodiment. The electrolyte layer 202 may be composed of a pressure-formed body or a sheet-shaped sintered body that is the ion conductor according to the second embodiment.

When lithium metal is not used as the negative electrode active material 205, the battery 1000 according to the third embodiment may be fabricated in the atmosphere.

For example, the battery 1000 according to the third embodiment may be produced by providing materials for forming the positive electrode, materials for forming the electrolyte layer, and materials for forming the negative electrode, and fabricating by a known method a stack in which the positive electrode, the electrolyte layer, and the negative electrode are arranged in this order.

### Example

The present disclosure will be described in greater detail hereinbelow with reference to EXAMPLES and COMPARATIVE EXAMPLES.

### Example 1

In EXAMPLE 1, ion conductors were prepared by a cation exchange method using a natural mineral as a starting material. Specifically, the ion conductors of EXAMPLE 1 were obtained by exchanging the cations (metal ions) present between layers in the natural mineral with Li ions.

### Example 1A

### Preparation of Ion Conductor

The ion conductor of EXAMPLE 1A was prepared by a hydrochloric acid method (namely, an ion exchange method using an aqueous lithium chloride solution) using bentonite as a starting material.

Specifically, 0.0324 mol of the natural mineral, bentonite, was weighed and added to a 1 mol/L aqueous lithium chloride solution. Next, the aqueous solution was stirred for 1 hour while being ultrasonicated. After the stirring, the solution was dehydrated with a centrifuge. The solid component was collected and was added again to a 1 mol/L aqueous lithium chloride solution. Stirring and dehydration were performed three times in the manner described above. The centrifuge dehydration was performed at 5000 rpm for 10 minutes and then at 10000 rpm for 5 minutes.

To remove anions, the solid component obtained was washed with distilled water. The washing was performed until the pH of the solution in which the solid component had been submerged became neutral.

After the washing, the solid component was dehydrated and was vacuum dried at 200° C. for 48 hours.

A powder of particles of the ion conductor of EXAMPLE 1A was thus obtained.

### Composition Analysis

The composition of the ion conductor prepared was determined by EPMA semi-quantitative analysis. Furthermore, the composition of the interlayer metal ions was quantitatively analyzed by ICP-AES. The composition of the ion conductor according to EXAMPLE 1A is described in Table 1 later.

### X-Ray Diffractometry

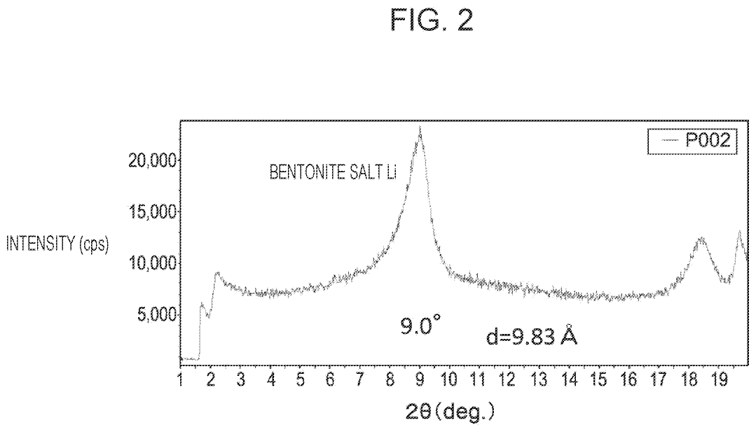

FIG. 2 is a graph illustrating an X-ray diffraction pattern of the ion conductor according to EXAMPLE 1A. The results illustrated in FIG. 2 were measured by the following method.

The solid electrolyte material according to EXAMPLE 1A was sampled into an XRD airtight jig in an argon atmosphere having a dew point less than or equal to −60° C. Next, an X-ray diffraction pattern of the ion conductor of EXAMPLE 1A was measured with an X-ray diffractometer (MiniFlex 600 manufactured by Rigaku Corporation) in a dry atmosphere having a dew point less than or equal to −45° C. Cu-Kα radiations (1.5405 Å and 1.5444 Å wavelengths) were used as the X-ray source.

As illustrated in FIG. 2, a peak occurred at a diffraction angle 2θ of 9.0° in the X-ray diffraction pattern of the ion conductor of EXAMPLE 1A. Thus, it is probable that the ion conductor of EXAMPLE 1A have a layered framework structure. It was also confirmed that the ion conductor of EXAMPLE 1A was a layered amorphous material.

### Evaluation of Electrochemical Characteristics

Electrochemical characteristics of the ion conductor of EXAMPLE 1A were evaluated below.

The ion conductor of EXAMPLE 1A was manually ground for 1 hour using an agate mortar and an agate pestle, and the particles were classified using a mesh filter with an opening of 3 μm. The powder with a particle size less than or equal to 3 μm that had passed through the mesh was collected and was pelletized. The amount of the ion conductive powder of EXAMPLE 1A that was used was about 0.1 g.

FIG. 3 is a sectional view illustrating a schematic configuration of a pressure forming die. The ion conductor of EXAMPLE 1A was compressed using the pressure forming die illustrated in FIG. 3 and was tested to measure the ion conductivity.

The pressure forming die included an upper punch 20, a lower punch 30, and a die 40. The upper punch 20 and the lower punch 30 were made of stainless steel (SUS). The die 40 was a resin mold and had an internal hole diameter of 10 mm (0.785 cm²).

The inside of the pressure forming die was filled with the powder (about 0.1 g) of the ion conductor of EXAMPLE 1A, and a pressure of 20 MPa was applied using the upper punch 20 and the lower punch 30. The hydraulic pump of the press machine used to apply the pressure had a cylinder diameter of 14.5 cm². The impedance of the ion conductor of EXAMPLE 1A was measured at room temperature (25° C.) while applying the pressure. By the AC impedance method, the bulk resistance was estimated to be at about 1 kHz, and the ion conductivity of the ion conductor of EXAMPLE 1A was calculated from that value of resistance.

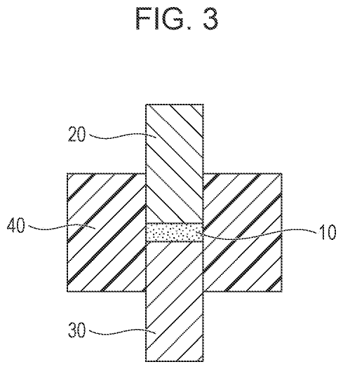

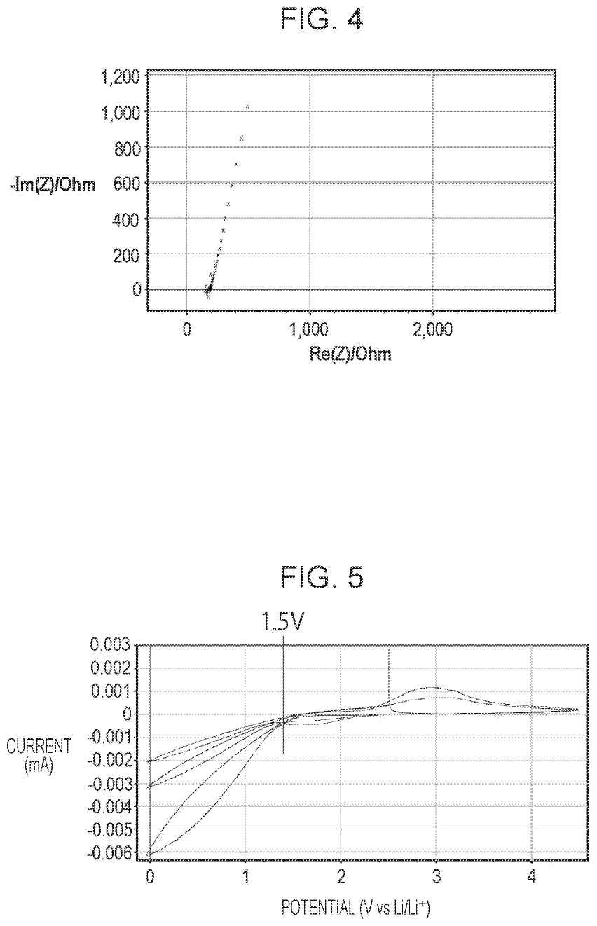

FIG. 4 is a graph illustrating a Cole-Cole plot obtained by the impedance measurement of the ion conductor according to EXAMPLE 1A.

FIG. 5 is a graph illustrating the results of CV measurement of the ion conductor according to EXAMPLE 1A.

The CV measurement was performed by DC constant voltage electrolysis (CV: cyclic voltammetry).

From FIG. 5, the oxidation-reduction withstand voltage (that is, the potential window) of the ion conductor of EXAMPLE 1A was studied. On the oxidation side, no oxidation current flowed up to 5 V versus a Li counter electrode. On the other hand, a reduction current was observed at 1.5 V and less. Thus, the withstand voltage of the ion conductor of EXAMPLE 1A was determined to be 1.5 V to 5.0 V versus the Li potential. Furthermore, it was shown that the ion conductor of EXAMPLE 1A had no electron conductivity in the range of 1.5 V to 5.0 V versus the Li potential.

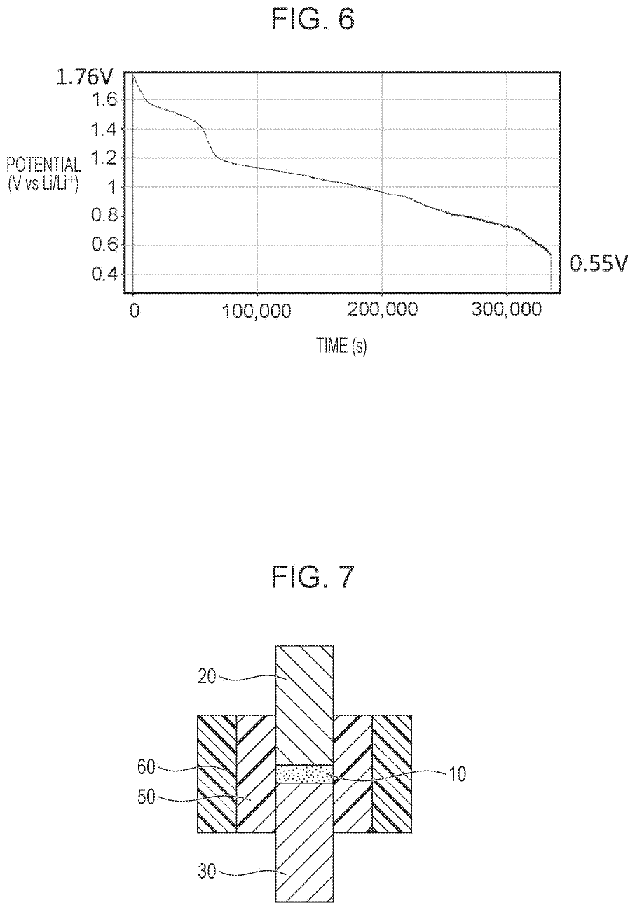

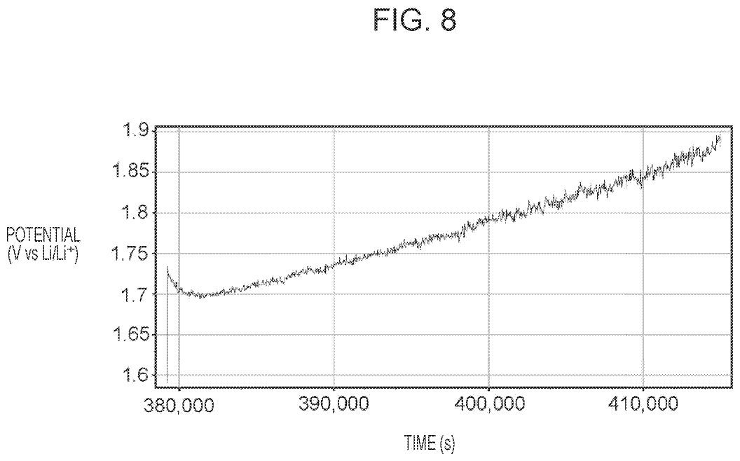

FIG. 6 is a graph illustrating discharge characteristics of a half-cell fabricated using the ion conductor of EXAMPLE 1A. FIG. 8 is a graph illustrating charge characteristics of the half-cell fabricated using the ion conductor of EXAMPLE 1A. The half-cell was fabricated with use of a pressure forming die illustrated in FIG. 7.

In the fabrication of the half-cell using the ion conductor of EXAMPLE 1A, LTO and lithium metal were used for the working electrode (the positive electrode) and the counter electrode (the negative electrode), respectively. Whether an electromotive force was generated in the half-cell that had been assembled was determined by measuring the open-circuit voltage due to the migration of lithium ions. An electromotive force keeping a stable potential as the open-circuit voltage was confirmed for at least the first three minutes.

Furthermore, the half-cell was discharged at a constant current corresponding to 0.01C rate to transfer Li from the negative electrode to the positive electrode. Next, the half-cell was charged at a constant current corresponding to 0.01C rate to transfer Li from the positive electrode back to the negative electrode.

The above charge-discharge test was performed on each of four half-cells of EXAMPLE 1A. As a result, the half-cells of EXAMPLE 1A generated an electromotive force of 1.2 V to 1.78 V. The closeness to the theoretical electromotive force indicated the flow of lithium ions. In other words, it was confirmed that the ion conductor of EXAMPLE 1A had lithium ion conductivity. Furthermore, the above measurement confirmed that a battery using the ion conductor of EXAMPLE 1A was chargeable and dischargeable as a lithium ion secondary battery. Incidentally, the discharge characteristics illustrated in FIG. 6 are those of the half-cell that generated an electromotive force of 1.78 V among the four half-cells.

Furthermore, a Li pump cell was fabricated using the ion conductor of EXAMPLE 1A and Li metal electrodes, and a blocking electrode cell was produced that was composed of blocking electrodes consisting solely of SUS pin current collectors without Li metal electrodes. These cells were tested to evaluate whether the ion conductor of EXAMPLE 1A functioned as an ion conductor. The Li pump cell and the blocking electrode cell that were used for the evaluation were fabricated using the pressure forming die illustrated in FIG. 3.

The pressure forming die included an upper punch 20, a lower punch 30, and a die 40. The upper punch 20 and the lower punch 30 were made of stainless steel (SUS). The die 40 was a resin mold and had an internal hole diameter of 10 mm (0.785 cm²).

The blocking electrode cell composed solely of SUS pin current collectors was produced by filling the inside of the pressure forming die with the powder (about 0.1 g) of the ion conductor of EXAMPLE 1A and applying a pressure of 36 MPa using the upper punch 20 and the lower punch 30. The hydraulic pump of the press machine used to apply the pressure had a cylinder diameter of 14.5 cm². Meanwhile, the Li pump cell having Li metal electrodes was fabricated by removing the punches from the blocking electrode cell, placing a Li metal foil (p: 10 mm, thickness: 0.3 mm) on and under the ion conductor compact, and compressing the unit with the upper and lower punches at a pressure of 3 MPa.

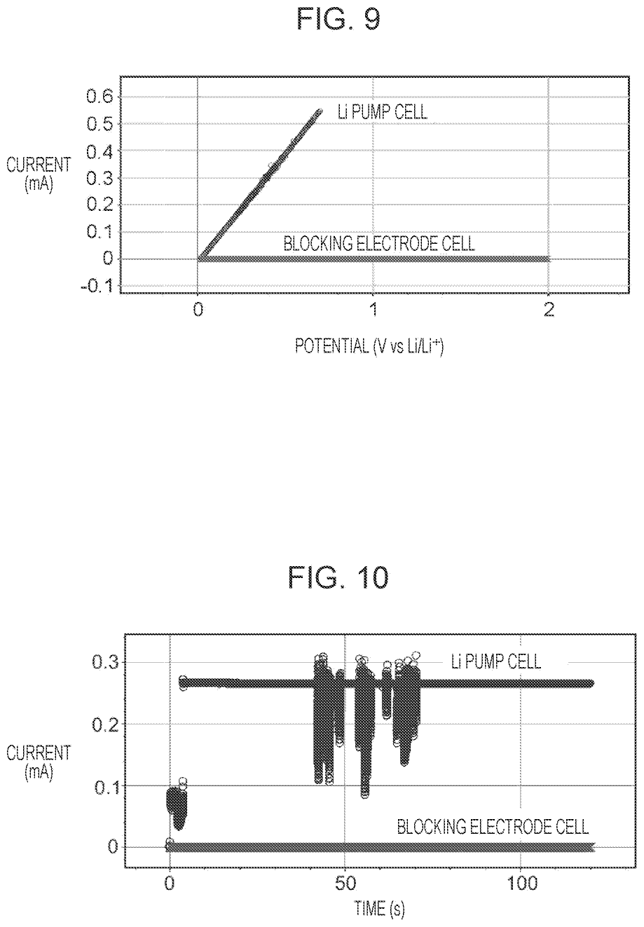

A voltage was applied to each of the cells at room temperature, and the value of the ion current that flowed was measured. FIG. 9 is a graph illustrating direct-current conduction characteristics (i-V characteristics) of the Li pump cell fabricated using the ion conductor of EXAMPLE 1A and Li metal electrodes, and the blocking electrode cell composed of blocking electrodes consisting solely of SUS pin current collectors without Li metal electrodes. FIG. 10 is a graph illustrating the results of a two-minute continuous conduction test of the Li pump cell fabricated using the ion conductor of EXAMPLE 1A and Li metal electrodes, and the blocking electrode cell composed of blocking electrodes consisting solely of SUS pin current collectors without Li metal electrodes. In the two-minute continuous conduction test, a constant voltage of 0.35 V was applied to the cell for 2 minutes while following changes in ion current.

The results confirmed that a current of Li ions flowed in the Li pump cell. In contrast, there was no current flowing in the blocking electrode cell without Li sources. From these results, it is clear that the ion conductor of EXAMPLE 1A has no electron conductivity and functions as a Li ion conductor.

### Example 1B to 1E and COMPARATIVE EXAMPLES 1F to 1I

The starting materials that were used were bentonite (EXAMPLE 1B), montmorillonite (EXAMPLE 1C), saponite (EXAMPLE 1D), and beidellite (EXAMPLE 1E).

In EXAMPLE 1B, an aqueous lithium nitrate solution was used instead of the aqueous lithium chloride solution. That is, cation exchange was performed by a nitric acid method.

Ion conductors of EXAMPLES 1B to 1E were obtained in the same manner as in EXAMPLE 1A except for the above differences.

The compositions of the ion conductors of EXAMPLES 1B to 1E are described in Table 1. The compositions of the ion conductors of EXAMPLES 1B to 1E were analyzed in the same manner as in EXAMPLE 1A.

In COMPARATIVE EXAMPLES 1F to 1I, the natural minerals used as the starting materials in EXAMPLES 1A to 1E were used as such. That is, cation exchange was not performed.

TABLE 1

| | | Cation exchange | |
|---|---|---|---|
| | Starting material | method | Composition |
| EX. 1A | Bentonite | Hydrochloric acid | Fe_{0.1}(Al_{1.74}Mg_{0.36})Si₄O₁₀(OH⁻Li⁺_{0.12})₂ |
| | | method | |
| EX. 1B | Bentonite | Nitric acid method | Fe_{0.1}(Al_{1.74}Mg_{0.36})Si₄O₁₀(OH⁻Li⁺_{0.119})₂ |
| EX. 1C | Montmorillonite | Hydrochloric acid | Fe_{0.1}(Al_{0.87}Mg_{0.25})Si₄O₁₀(OH⁻Li⁺_{0.12})₂ |
| | | method | |
| EX. 1D | Saponite | Hydrochloric acid | Mg₃(Si_{3.77}Al_{0.33})O₁₀(OH⁻Li⁺_{0.25})₂ |
| | | method | |
| EX. 1E | Beidellite | Hydrochloric acid | Al₂(Si_{3.5}Al_{0.5})O₁₀(OH⁻Li⁺_{0.25})₂ |
| | | method | |
| COMP. | Bentonite | — | Fe_{0.1}(Al_{1.74}Mg_{0.36})Si₄O₁₀(OH⁻Na⁺_{0.12})₂ |
| EX. 1F | | | |
| COMP. | Montmorillonite | — | Fe_{0.1}(Al_{0.87}Mg_{0.25})Si₄O₁₀(OH⁻Na⁺_{0.12})₂ |
| EX. 1G | | | |
| COMP. | Saponite | — | Mg₃(Si_{3.77}Al_{0.33})O₁₀(OH⁻Na⁺_{0.25})₂ |
| EX. 1H | | | |
| COMP. | Beidellite | — | Al₂(Si_{3.5}Al_{0.5})O₁₀(OH⁻Na⁺_{0.25})₂ |
| EX. 1I | | | |

The ion conductors of EXAMPLES 1B to 1E and the natural minerals of COMPARATIVE EXAMPLES 1F to 1I were analyzed in the same manner as in EXAMPLE 1A to evaluate X-ray diffraction characteristics and electrochemical characteristics. The results are described in Table 2.

The discharge characteristics of the half-cells using the materials of COMPARATIVE EXAMPLES 1F to 1I showed a gradual decrease in open-circuit voltage and the voltage was unstable. Furthermore, the voltage decreased to 0.4 V within 30 minutes. This is a situation where Li ions cannot be supplied. That is, the materials of COMPARATIVE EXAMPLES 1F to 1I will not function as lithium ion conductors.

TABLE 2

| | | | | Half-cell | |
|---|---|---|---|---|---|
| | XRD peak | Ion conductivity | Potential | electromotive | |
| | (2θ/θ) | (S/cm) | window vs. Li | force | |
| EX. 1A | 9.0° | 5.2 × 10⁻⁵ | 1.5-5 V | 1.2-1.78 | V |
| EX. 1B | 6.4° | 9.5 × 10⁻⁶ | 1.5-5 V | 1.1-1.8 | V |
| EX. 1C | 7.3° | 6.5 × 10⁻⁴ | 1.5-5 V | 1.0-1.7 | V |
| EX. 1D | 7.0° | 2.6 × 10⁻⁵ | 1.5-5 V | 0.9-1.76 | V |
| EX. 1E | 4.8° | 5.4 × 10⁻⁶ | 1.5-5 V | 0.8-1.8 | V |

| | | | | |
|---|---|---|---|---|
| COMP. | 9.2° | 4.1 × 10⁻⁴ | 1.5-5 V | Unstable |
| EX. 1F | | | | |
| COMP. | 8.9° | 9.8 × 10⁻⁴ | 1.5-5 V | Unstable |
| EX. 1G | | | | |
| COMP. | 8.0° | 6.1 × 10⁻⁴ | 1.5-5 V | Unstable |
| EX. 1H | | | | |
| COMP. | 5.8° | 7.8 × 10⁻⁵ | 1.5-5 V | Unstable |
| EX. 1I | | | | |

### Discussion

The above results confirmed that the ion conductors of EXAMPLES 1A to 1E had a layered crystal structure and had lithium ion conductivity. Specifically, it was confirmed that the ion conductors of EXAMPLES 1A to 1E were suited for lithium ion secondary batteries. In contrast, the materials of COMPARATIVE EXAMPLES 1F to 1I having a similar crystal structure exhibited an unstable half-cell electromotive force. Here, the unstable electromotive force means that a voltage drop occurred in about 30 seconds. This suggests that the materials of COMPARATIVE EXAMPLES 1F to 1I do not have lithium ion conductivity. Specifically, it was confirmed that the ion conductors of COMPARATIVE EXAMPLES 1F to 1I were unsuited for lithium ion secondary batteries. Incidentally, the ion conduction of Na⁺ or H⁺ is probably the reason why the materials of COMPARATIVE EXAMPLES 1F to 1I exhibited an ion conductivity comparable to those of the ion conductors of EXAMPLES 1A to 1E.

### Example 2

In EXAMPLE 2, pressure-formed bodies (here, pellets) and sintered bodies were prepared using the ion conductor of EXAMPLE 1A for evaluation.

### Example 2A

Particles of the ion conductor of EXAMPLE 1A were obtained in the same manner as in EXAMPLE 1A. The ion conductor of EXAMPLE 1A was manually ground for 2 hours using an agate mortar and an agate pestle. Next, particles larger than 5 μm were removed by classification. The classified particles were analyzed with laser diffraction/scattering grain size distribution analyzer MT3300 II (manufactured by MicrotracBEL Corp.) to measure the average particle size. The classification was performed using a mesh filter with an opening of 5 μm. The measurement results are described in Table 3.

Approximately 0.1 g of the pulverized ion conductor particles were pelletized in the same manner as in the evaluation of the electrochemical characteristics of the ion conductor of EXAMPLE 1A. The pellets were subjected to impedance measurement and CV measurement. The pressure applied for the pelletization ranged from 3 MPa to 36 MPa, and the bulk densities of the pellets were calculated and compared with the true density.

In Table 3, the trailing numbers at the end of EXAMPLE 2 indicate the press pressure (MPa). For example, “EXAMPLE 2 Å-9” means that the gauge pressure in the pelletization of the ion conductor powder was 9 MPa.

### Example 2B to 2D

In EXAMPLE 2B, the manual grinding was performed for 2 hours and no classification was made. The press pressure was 20 MPa. The experiment was conducted in the same manner as in EXAMPLE 2A except for the above differences.

In EXAMPLE 2C, the manual grinding was immediately followed by 1 hour of dry grinding with a planetary ball mill, and no classification was made. The press pressure was 20 MPa. The experiment was conducted in the same manner as in EXAMPLE 2A except for the above differences.

In EXAMPLE 2D, the manual grinding was immediately followed by 1 hour of wet grinding with a planetary ball mill and cyclohexane solvent, and no classification was made. The press pressure was 20 MPa. The experiment was conducted in the same manner as in EXAMPLE 2A except for the above differences.

### Example 2E and 2F

In EXAMPLE 2E, the ion conductor powder prepared in EXAMPLE 2 Å, specifically, the “pulverized ion conductor particles” used in EXAMPLE 2A to fabricate a pressure-formed body was used. The ion conductor powder was formed into a sheet and was heat-treated to give a sintered body.

In EXAMPLE 2E, 3 g of the powder of the ion conductor of EXAMPLE 2A was added to 20 cc of distilled water and the mixture was stirred for 3 hours while being ultrasonicated. The mixture was transferred to a 6 cm diameter Petri dish and was allowed to sediment for 24 hours. Next, the Petri dish was transferred onto a hot plate at 120° C., and the supernatant distilled water was evaporated for 24 hours.

The sheet-shaped ion conductor left on the Petri dish was transferred to a magnetic or alumina sheath and was heat-treated and dehydrated in an electric furnace at 250° C. for 2 hours. A gauge pressure was applied to the sheet. An ion conductor sintered body of EXAMPLE 2E-10 was thus obtained.

In EXAMPLE 2F, the powder of the ion conductor of EXAMPLE 2C was used instead of the powder of the ion conductor of EXAMPLE 2 Å. A sheet-shaped ion conductor sintered body of EXAMPLE 2F was obtained in the same manner as in EXAMPLE 2E except for the above difference.

The hydraulic pump of the press machine used to apply a pressure had a cylinder diameter of 14.5 cm².

The ion conductors of EXAMPLE 2 were analyzed in the same manner as in EXAMPLE 1 to determine the density ratio ([bulk density/true density]×100) and the ion conductivity. The results are described in Tables 3 and 4.

TABLE 3

| | | Average | Press | Den- | Ion |
|---|---|---|---|---|---|
| | | particle | pres- | sity | conduc- |
| | | size | sure | ratio | tivity |
| | Pulverization | (μm) | (MPa) | (%) | (S/cm) |
| EX. 2A-3 | Manual grinding 1 h | 3 | 3 | 56 | 2 × 10⁻⁷ |
| | Classification | | | | |
| EX. 2A-6 | Manual grinding 1 h | 3 | 6 | 58 | 3 × 10⁻⁷ |
| | Classification | | | | |
| EX. 2A-9 | Manual grinding 1 h | 3 | 9 | 60 | 3.1 × 10⁻⁶ |
| | Classification | | | | |
| EX. 2A-15 | Manual grinding 1 h | 3 | 15 | 65 | 1.2 × 10⁻⁵ |
| | Classification | | | | |
| EX. 2A-20 | Manual grinding 1 h | 3 | 20 | 68 | 5.2 × 10⁻⁵ |
| | Classification | | | | |
| EX. 2A-28 | Manual grinding 1 h | 3 | 28 | 72 | 8.1 × 10⁻⁵ |
| | Classification | | | | |
| EX. 2A-36 | Manual grinding 1 h | 3 | 36 | 75 | 9.6 × 10⁻⁵ |
| | Classification | | | | |
| EX. 2B-20 | Manual grinding 2 h | 5 | 20 | 62 | 3.1 × 10⁻⁶ |
| EX. 2C-20 | Manual grinding 1 h | 2.6 | 20 | 71 | 7.1 × 10⁻⁵ |
| | Dry ball grinding | | | | |
| EX. 2D-20 | Manual grinding 1 h | 2.9 | 20 | 68 | 9.8 × 10⁻⁵ |
| | Wet ball grinding | | | | |

TABLE 4

| | | Average | Press | Den- | Ion |
|---|---|---|---|---|---|
| | | particle | pres- | sity | conduc- |
| | | size | sure | ratio | tivity |
| | Pulverization | (μm) | (MPa) | (%) | (S/cm) |
| EX. 2E-6 | Manual grinding 1 h | 3 | 6 | 57 | 4 × 10⁻⁷ |
| | Classification | | | | |
| EX. 2E-10 | Manual grinding 1 h | 3 | 10 | 60 | 1.5 × 10⁻⁶ |
| | Classification | | | | |
| EX. 2F-10 | Manual grinding 1 h | 2.6 | 10 | 63 | 4.2 × 10⁻⁵ |
| | Dry ball grinding | | | | |

### DISCUSSION

As described in Tables 3 and 4, the compacted pellets of the powder of the ion conductor of EXAMPLE 1, and the sintered sheets of the powder of the ion conductor of EXAMPLE 1 were shown to have ion conductivity.

As clear from Tables 3 and 4, the ion conductors exhibited higher ion conductivity when the density ratio was greater than or equal to 60%.

### Example 3

In EXAMPLE 3, batteries were fabricated using the ion conductors of EXAMPLE 1 and were evaluated. In this example, the ion conductors of EXAMPLE 1 were used as solid electrolytes in solid electrolyte layers, and batteries were fabricated by interposing the solid electrolyte layer between a positive electrode and a negative electrode. Because the ion conductors used were oxide-based materials, the fabrication of the batteries of EXAMPLE 3 was feasible in the atmosphere. EXAMPLE 3 will demonstrate that the batteries are secondary batteries having heat resistance of 100° C. and 200° C. and being repeatedly chargeable and dischargeable at room temperature and 85° C.

### Example 3A

In EXAMPLE 3 Å, a powder of the ion conductor of EXAMPLE 1A was used. The powder of the ion conductor of EXAMPLE 1A was one obtained by 1 hour of manual grinding followed by classification to remove particles larger than 5 μm particle size. Approximately 100 mg of the powder of the ion conductor was charged to fill the inside of a pressure forming die illustrated in FIG. 7. An electrolyte layer was thus formed.

Similarly to the pressure forming die illustrated in FIG. 3, the pressure forming die illustrated in FIG. 7 included an upper punch 20 (φ: 9.4 mm), a lower punch 30 (φ: 9.4 mm), and a die. The upper punch 20 and the lower punch 30 were made of SUS. The die was composed of an inner portion 50 that was an insulating sheet, and an outer portion 60 made of SUS.

LTO as a positive electrode active material, the powder of the ion conductor of EXAMPLE 1A, and a carbon conductive material (VGCF (registered trademark)) were provided so that the mass ratio would be LTO:ion conductor:VGCF=30:65:5. A positive electrode mixture was thus obtained. 15 mg of the positive electrode mixture was placed onto one side of the electrolyte layer formed inside the pressure forming die, and a pressure of 36 MPa was applied to the stack.

Next, an In metal foil, a Li metal foil, and an In metal foil were laminated as a negative electrode onto the other side of the electrolyte layer inside the pressure forming die. A pressure of about 2 MPa was applied to the stack. All the operations except the placement of the lithium metal in the negative electrode were carried out in the air atmosphere at room temperature.

A battery of EXAMPLE 3A was thus obtained.

The positive electrode active material and the ion conductor had been individually exposed directly to a gas burner flame beforehand to confirm that they were not ignitable.

The battery of EXAMPLE 3A was placed in thermostatic chambers at 100° C. and 200° C. for 24 hours. The ion conductivity was confirmed to have scarcely changed before and after the thermostatic chamber treatment. Specifically, the battery was subjected to impedance measurement to determine the ion conductivity before the battery was placed in the thermostatic chamber and after the battery was held in the thermostatic chamber for 24 hours and returned to room temperature. Table 5 describes the recovery ratio of the ion conductivity of the battery after the thermostatic chamber treatment relative to the ion conductivity of the battery before the thermostatic chamber treatment.

Next, the battery of EXAMPLE 3A was subjected to a charge-discharge test to examine whether the battery was chargeable and dischargeable at room temperature (25° C.) and 85° C. After the presence of a predetermined electromotive force was checked, the battery was subjected to constant current discharging and constant current charging.

The 0.01C discharge rate and the 0.01C charge rate were determined from the amount of electricity that could be discharged to the positive electrode, and the feasibility of charging and discharging at these rates was examined. In this manner, whether the battery was chargeable and dischargeable as a lithium ion all-solid-state secondary battery was evaluated.

The charge-discharge efficiency was determined from the results of the charge-discharge test of the battery of EXAMPLE 3 Å. The charge-discharge efficiency was calculated from discharge capacity/charge capacity×100.

### Examples 3B to 3F

In EXAMPLE 3B, the ion conductor of EXAMPLE 1C was used instead of the ion conductor of EXAMPLE 1A.

In EXAMPLE 3C, the ion conductor of EXAMPLE 1D was used instead of the ion conductor of EXAMPLE 1A.

In EXAMPLE 3D, the ion conductor of EXAMPLE 1E was used instead of the ion conductor of EXAMPLE 1A.

In EXAMPLE 3E, the positive electrode active material was changed from LTO to LiCoO₂. Furthermore, the negative electrode was formed by placing a negative electrode mixture onto the electrolyte layer. The negative electrode mixture included anatase-type TiO₂ as a negative electrode active material, the ion conductor, and a carbon conductive material (VGCF (registered trademark)) in a mass ratio anatase-type TiO₂:ion conductor:VGCF=40:50:10. The positive electrode active material and the negative electrode active material had been individually exposed directly to a gas burner flame beforehand to confirm that they were not ignitable.

In EXAMPLE 3F, the positive electrode active material was changed from LTO to LiCoPO₄. Furthermore, the negative electrode was formed by placing the negative electrode mixture of EXAMPLE 3E onto the electrolyte layer.

In EXAMPLE 3G, the positive electrode active material was changed from LTO to LiNi_{0.33}Mn_{0.33}Co_{0.33}O₂ (NMC). Furthermore, the negative electrode was formed by placing a negative electrode mixture onto the electrolyte layer. The negative electrode mixture included LTO as a negative electrode active material, the ion conductor, and a carbon conductive material (VGCF (registered trademark)) in a mass ratio of LTO:ion conductor:VGCF=40:50:10. The positive electrode active material and the negative electrode active material had been individually exposed directly to a gas burner flame beforehand to confirm that they were not ignitable.

Batteries of EXAMPLES 3B to 3G were obtained in the same manner as in EXAMPLE 3A except for the above differences.

The batteries of EXAMPLES 3B to 3G were subjected to a thermostatic chamber evaluation and a charge-discharge test in the same manner as in EXAMPLE 3 Å. The results are described in Table 5.

TABLE 5

| | Cell structure (Positive | Test at | Test at | | Charge- |
|---|---|---|---|---|---|
| | electrode/ion | 100° C. | 200° C. | Charge-discharge | discharge |
| | conductor/negative | (Recovery | (Recovery | efficiency at | efficiency |
| | electrode) | ratio) | ratio) | room temperature | at 85° C. |
| EX. 3A | LTO/EX. 1A/Li metal | 98% | 97% | 55% | 100% |
| EX. 3B | LTO/EX. 1C/Li metal | 98% | 97% | 65% | 100% |
| EX. 3C | LTO/EX. 1D/Li metal | 98% | 97% | 52% | 100% |
| EX. 3D | LTO/EX. 1E/Li metal | 98% | 97% | 60% | 100% |
| EX. 3E | LCO/EX. 1A/TiO₂ | 100% | 99% | 35% | 95% |
| EX. 3F | LCPO/EX. 1A/TiO₂ | 100% | 99% | 45% | 98% |
| EX. 3G | NMC/EX. 1A/LTO | 100% | 100% | 100% | 100% |

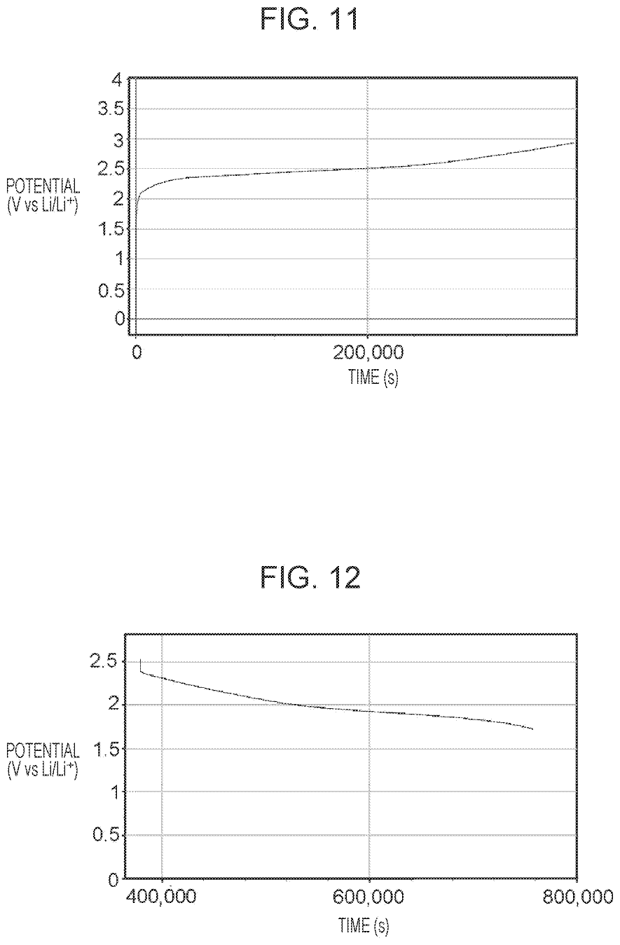

FIG. 11 is a graph illustrating the charge characteristics of the battery of EXAMPLE 3G. FIG. 12 is a graph illustrating the discharge characteristics of the battery of EXAMPLE 3G.

### DISCUSSION

The gas burner test confirmed that the ion conductors of EXAMPLES 1A to 1E were not ignitable. The non-ignitability was also confirmed of the positive electrode active materials and the negative electrode active materials except Li metal. Thus, the batteries of EXAMPLES 3A to 3G are incombustible all-solid-state lithium ion batteries.

The batteries that do not use a Li metal negative electrode (namely, the batteries of EXAMPLES 3E, 3F, and 3G) are synthesizable in the air atmosphere at room temperature.

As described in Table 5, all the batteries of EXAMPLE 3 recovered the ion conductivity by a ratio greater than or equal to 97% after the heat resistance tests at 100° C. and 200° C. Thus, the batteries of EXAMPLE 3 were shown to have high heat resistance.

As clear from the results of the charge-discharge test, the batteries of EXAMPLE 3 were dischargeable and chargeable with a charge-discharge efficiency greater than or equal to 35% at room temperature and 85° C.

The solid electrolyte material of the present disclosure is used in, for example, batteries, such as all-solid-state lithium ion secondary batteries.

What is claimed is:

1. An ion conductor comprising:
a Li ion as a Li ion conductive species; and
a layered framework structure comprising Al, Si, and O,
the Li ion being located between layers in the layered framework structure.

2. The ion conductor according to claim 1, wherein
the layered framework structure comprises at least one selected from the group consisting of Al oxides having an octahedral structure and Si oxides having a tetrahedral structure.

3. The ion conductor according to claim 1, wherein
an X-ray diffraction pattern obtained by X-ray diffractometry of the ion conductor using Cu-Kα radiation has a peak in a range of diffraction angles 2θ greater than or equal to 2° and less than or equal to 10°.

4. The ion conductor according to claim 1, wherein
the layered framework structure further comprises M, and
M is at least one element selected from the group consisting of divalent metal elements and trivalent metal elements.

5. The ion conductor according to claim 4, wherein
M is at least one selected from the group consisting of Mg, Fe, Mn, and Zn.

6. The ion conductor according to claim 1, wherein
the ion conductor is represented by:
M1ₐ1(Al_{b}1M2_{c}1)(Si_{d}1 Å1ₑ1)O₁₀(OH⁻Li⁺ₓ1)₂ compositional formula (1) or
M1ₐ₂(M2_{b2}Å1_{c2})(Si_{d2}Å1ₑ₂)O₁₀(OH⁻Li⁺ₓ₂)₂, compositional formula (2)
wherein
M1 is at least one element selected from trivalent metal elements,
M2 is at least one element selected from divalent metal elements,
the compositional formula (1) satisfies 0≤a1<0.5, 0≤b1≤2, 0≤c1≤2, 0≤d1≤4, 0≤e1≤0.5,and 0<x1≤1, and
the compositional formula (2) satisfies 0≤a2<0.5, 0≤b2≤3, 0≤c2≤2, 0≤d2≤4, 0≤e2≤0.5,and 0<x2≤1.

7. The ion conductor according to claim 6, wherein
the ion conductor is represented by the compositional formula (1) in which M1 is Fe, M2 is Mg, and e1=0.

8. The ion conductor according to claim 6, wherein
the ion conductor is represented by the compositional formula (2) in which M1 is Fe and M2 is Mg.

9. The ion conductor according to claim 1, wherein
the ion conductor is a pressure-formed body.

10. The ion conductor according to claim 9, wherein
the pressure-formed body is a solid electrolyte.

11. The ion conductor according to claim 1, wherein
the ion conductor is a sintered body.

12. The ion conductor according to claim 11, wherein
the sintered body is a solid electrolyte.

13. The ion conductor according to claim 1, wherein
the bulk density of the ion conductor is greater than or equal to 60% of the true density of the ion conductor.

14. The ion conductor according to claim 1, wherein
the ion conductor is particles, and
the average particle size of the ion conductor is less than or equal to 5 μm.

15. A battery comprising:
a positive electrode;
a negative electrode; and
an electrolyte layer disposed between the positive electrode and the negative electrode, wherein
at least one selected from the group consisting of the positive electrode, the electrolyte layer, and the negative electrode comprises the ion conductor described in claim 1.
